(19) United States
(12) Patent Application Publication
(10) Pub. No.: US 2026/0056117 A1
(43) Pub. Date: Feb. 26, 2026

(54) Systems and Methods for Fiber-Coupled Microtip Sensors

(71) Applicant: California Institute of Technology, Pasadena, CA (US)

(72) Inventors: Lance E. Christensen, Baldwin Park, CA (US); Henry Abakians, Pasadena, CA (US)

(73) Assignee: California Institute of Technology, Pasadena, CA (US)

(21) Appl. No.: 19/310,738

(22) Filed: Aug. 26, 2025

Related U.S. Application Data
(60) Provisional application No. 63/687,109, filed on Aug. 26, 2024.

(51) Int. Cl. G01N 21/25; G01N 21/39

(52) U.S. Cl. CPC G01N 21/255; G01N 21/39; G01N 2201/0633; G01N 2201/08; G01N 2201/127

(57) ABSTRACT

Systems and methods for fiber optic-coupled microtip sensors are described. Such sensors can be combined with tunable lasers to achieve precision detection of various types of gaseous chemical substances.

### CROSS-REFERENCE TO RELATED APPLICATIONS

The current application claims the benefit, under 35 U.S.C. § 119 (e), of U.S. Provisional Patent Application No. 63/687,109, entitled “Fiber-Coupled Microtip Tunable Laser Spectrometer” filed Aug. 26, 2024. The disclosure of U.S. Provisional Patent Application No. 63/687,109 is hereby incorporated by reference in its entirety for all purposes.

### STATEMENT OF FEDERALLY SPONSORED RESEARCH

This invention was made with government support under Grant No. 80NM0018D0004 awarded by NASA (JPL). The government has certain rights in the invention.

### FIELD OF THE INVENTION

The present disclosure generally relates to systems and methods for fiber-coupled microtip sensors.

### BACKGROUND OF THE INVENTION

Optical fibers, as transducers for light, can be used in optical sensing devices. The propagation of light in an optical fiber is confined in the core of the fiber, based on the total internal reflection principle and has near-zero propagation loss within the cladding. Due to the demand for small-size sensors for remote and real-time monitoring, optical fibers are becoming a versatile platform for chemical and/or bio sensors due to their cost-effectiveness, small-size, flexibility, robustness, no electromagnetic interference, chemical inertness, lightweight, remote and multiplexed detection capability, etc. Fiber-optic sensors have been used in the areas of environmental monitoring, explosive gas detection, disease identification. Compared with other types of optical sensing techniques, fiber-optic sensors offer the versatilities of multiplex detection capability and remote monitoring in human-untouchable environments.

### SUMMARY OF THE INVENTION

Many embodiments are directed to systems and methods for fiber-coupled microtip sensors. Several embodiments use the fiber-coupled microtip sensors to detect various types of gases. In some embodiments, the fiber-coupled microtip sensors are used with tunable lasers to achieve precision detection.

Some embodiments include a gas sensor, comprising: a light source emitting a light; a first fiber optic connected to the light source, wherein a first end of the first fiber optic is configured to collimate the light; a second fiber optic with a first end separated by a fixed distance from the first end of the first fiber optic, wherein the collimated light emitted from the first end of the first fiber optic crosses the fixed distance and is received by the first end of the second fiber optic; wherein the light is coupled between the first end of the first fiber optic and the first end of the second fiber optic; a stabilizing unit configured to hold the first end of the first fiber optic and the first end of the second fiber optic stationary and at the fixed distance to allow the coupling of the light in between; and a photodetector connected to the second fiber optic, wherein the photodetector measures an optical signal induced by a change in characters of the light in the fixed distance between the first end of the first fiber optic and the first end of the second fiber optic.

In some embodiments, the light source is a light emitting diode.

In some embodiments, the light source is a tunable laser.

In some embodiments, a wavelength or frequency of the tunable laser is tuned to a plurality of resonance lines of the gas.

In some embodiments, the tunable laser is a part of a laser package.

In some embodiments, the first fiber optic and the second fiber optic each comprise a fiber optic material that transmits the light.

In some embodiments, the fiber optic material is selected from the group consisting of: quartz, silica, fused silica, and ZBLAN glass.

In some embodiments, the first end of the first fiber optic comprises a straight side and a curved side, wherein the straight side collimates the light and the curved side transmits the collimated light to the first end of the second fiber optic.

In some embodiments, the fixed distance is selected based on a plurality of absorption features of the gas.

In some embodiments, the fixed distance is greater than or equal to 0.5 mm and less than or equal to 10 mm.

In some embodiments, the fixed distance is 1 mm.

In some embodiments, the stabilizing unit comprises a material of a similar coefficient of thermal expansion as the first fiber optic and/or the second fiber optic.

In some embodiments, the stabilizing unit comprises a material selected from the group consisting of: a nickel-cobalt ferrous alloy, a nickel-iron alloy, Kovar, and Invar.

In some embodiments, the gas sensor is a portion of a spacesuit or an in-situ resource utilization (ISRU) processing unit.

In some embodiments, the gas is selected from the group consisting of: carbon dioxide, oxygen, methane, and water vapor.

Some embodiments include a method for detecting a gas, comprising: measuring a concentration of the gas using a gas sensor, wherein the gas sensor comprises: a light source emitting a light; a first fiber optic connected to the light source, wherein a first end of the first fiber optic is configured to collimate the light; a second fiber optic with a first end separated by a fixed distance from the first end of the first fiber optic, wherein the collimated light emitted from the first end of the first fiber optic crosses the fixed distance and is received by the first end of the second fiber optic; wherein the light is coupled between the first end of the first fiber optic and the first end of the second fiber optic; a stabilizing unit configured to hold the first end of the first fiber optic and the first end of the second fiber optic stationary and at the fixed distance to allow the coupling of the light in between; and a photodetector connected to the second fiber optic, wherein the photodetector measures an optical signal induced by a change in characters of the light in the fixed distance between the first end of the first fiber optic and the first end of the second fiber optic; and determining the concentration of the gas based on the optical signal measured by the photodetector.

Some embodiments further comprise calibrating the gas sensor to a known concentration of the gas.

In some embodiments, the light source is a light emitting diode.

In some embodiments, the light source is a tunable laser.

In some embodiments, a wavelength or frequency of the tunable laser is tuned to a plurality of resonance lines of the gas.

In some embodiments, the tunable laser is a part of a laser package.

In some embodiments, the first fiber optic and the second fiber optic each comprise a fiber optic material that transmits the light.

In some embodiments, the fiber optic material is selected from the group consisting of: quartz, silica, fused silica, and ZBLAN glass.

In some embodiments, the first end of the first fiber optic comprises a straight side and a curved side, wherein the straight side collimates the light and the curved side transmits the collimated light to the first end of the second fiber optic.

In some embodiments, the fixed distance is selected based on a plurality of absorption features of the gas.

In some embodiments, the fixed distance is greater than or equal to 0.5 mm and less than or equal to 10 mm.

In some embodiments, the fixed distance is 1 mm.

In some embodiments, the stabilizing unit comprises a material of a similar coefficient of thermal expansion as the first fiber optic and/or the second fiber optic.

In some embodiments, the stabilizing unit comprises a material selected from the group consisting of: a nickel-cobalt ferrous alloy, a nickel-iron alloy, Kovar, and Invar.

In some embodiments, the gas sensor is a portion of a spacesuit or an in-situ resource utilization (ISRU) processing unit.

In some embodiments, the gas is selected from the group consisting of: carbon dioxide, oxygen, methane, and water vapor.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures and data, which are presented as exemplary embodiments of the disclosure and should not be construed as a complete recitation of the scope of the invention, wherein:

FIG. 1 illustrates a schematic of a fiber optic-coupled microtip sensor in accordance with an embodiment.

FIG. 2A illustrates a schematic of the microtip of a fiber optic-coupled microtip sensor in accordance with an embodiment.

FIG. 2B illustrates a photograph of the microtip of a fiber optic-coupled microtip sensor in accordance with an embodiment.

FIG. 3 illustrates a schematic of a fiber optic-coupled microtip sensor package in accordance with an embodiment.

FIG. 4A illustrates a schematic of implementation of the microtip of a fiber optic-coupled microtip sensor to measure gas concentration in a pipe in accordance with an embodiment.

FIG. 4B illustrates a schematic of implementation of the microtip of a fiber optic-coupled microtip sensor to measure a solid sample in accordance with an embodiment.

### DETAILED DESCRIPTION OF THE INVENTION

Optical fibers are light-transmitting waveguides with two primary components: a core made of glass and a cladding composed of a material with a lower refractive index than the core. The optical fiber is protected against physical damage and scattering losses produced by micro bending by an extra elastic layer as a buffer composed of plastic surrounding the cladding section. The jacket layer is the final layer, and it can be used to identify the fiber type. Because of its purity, quartz glass is used to make the majority of fibers. Total internal reflection occurs at the interface between the core and the cladding in optical fibers as long as the angle of incident light inside the core is greater than the critical angle. In this way, incident light is reflected back into the core and propagated through the fiber. If the light strikes the interface at a greater angle than the critical angle, it will not pass through the opposite medium.

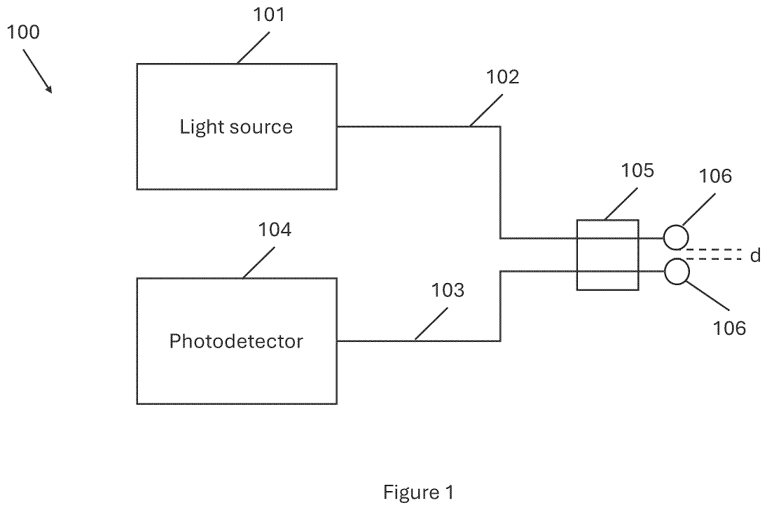

Many embodiments use fiber optics-coupled microtip sensors to measure target gas molecules in a given environment. Gases and/or vapors exhibit fundamental vibrational absorption bands, and the absorption of light by these fundamental bands provides a means for their detection. When gaseous substances encounter the sensor's microtips, a difference in optical signals due to absorption of light occurs. The change of optical signals can be measured by a photodetector. The sensor can detect various types of gases and/or vapors with the precision of trace amount. A block diagram of a fiber optic-coupled microtip gas sensor is shown in FIG. 1 in accordance with an embodiment. The gas sensing system 100 includes a light source 101, a signal input optical fiber 102, a signal output optical fiber 103, a photodetector 104, and a stabilizing unit 105. The microtips 106 of the optical fibers 103 and 104 are shaped in a desired geometry and separated by a desired distance d in order to sense the target gas. The microtips 106 can be symmetric or have different shapes. Although the microtips 106 are shown in circles in FIG. 1, they can have other shapes and/or curvatures. The light from the light source 101 can be transferred to the microtips 106 via the input optical fiber 102. The light is absorbed by the target gas at the microtips 106. The absorption of light changes the optical properties of the light. The output optical fiber 103 can transmit the resulting output light to the photodetector 104 for detection.

The light source 101 can be (but not limited to) lasers, laser diodes, tunable lasers, tunable laser diodes, light emitting diodes. In several embodiments, the wavelength of the laser can be tuned to detect the target gas. Using lasers as the light source 101 can improve detection accuracy and precision. In several embodiments, the optic fiber-coupled microtip tunable laser spectrometers offer a wide diversity of capability for highly sensitive measurement of gases and/or vapors. Because it is based on infrared laser absorption of individual rotational lines within a vibrational band, the method is sensitive (parts-per-billion to parts-per-trillion), direct, non-invasive, easy to calibrate, and unambiguous in its species identification without interference. In some embodiments, the optic fiber-coupled microtip tunable laser spectrometers can accurately measure carbon dioxide, oxygen, nitrogen, methane, and/or water vapor concentrations. The frequency of the laser can be calibrated corresponding to the gas resonance lines.

The input optical fiber 102 and the output optical fiber 103 can be any type of glass optical fibers. In some embodiments, the optical fibers can launch and receive tunable laser spectrometer laser light. The type of fiber optic materials used for the microtips 106 should be able to transmit the wavelength of light. Examples of fiber optic materials include (but are not limited to): quartz, silica, fused silica, ZBLAN glass. As can readily be appreciated, any of a variety of fiber optic materials can be utilized in the sensor as appropriate to the requirements of specific applications in accordance with various embodiments of the invention.

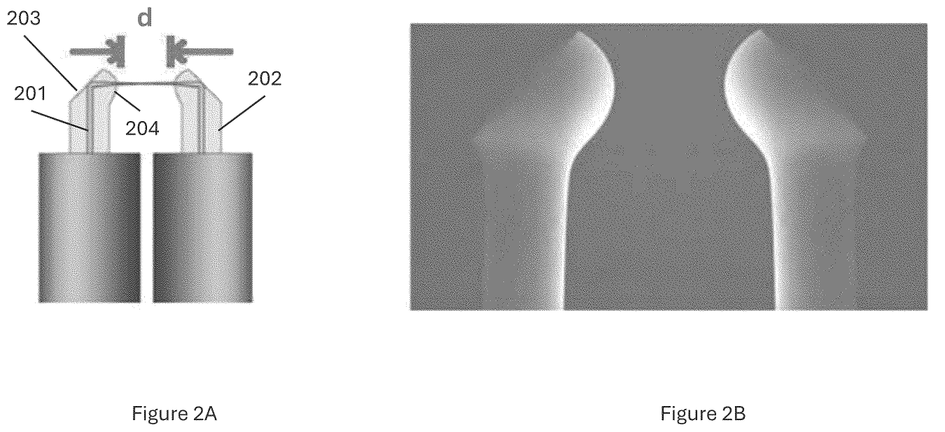

The microtips 106 of the optical fibers can be shaped in order to collimate the incoming light. FIG. 2A illustrates a schematic of the microtips of a fiber optic-coupled microtip gas sensor in accordance with an embodiment. As shown in FIG. 2A, the fiber optics can transmit the incoming light 201. The microtips 202 are shaped and curved to collimate light 201. The incoming light 201 is reflected by the straight side 203 of the microtip and collimated by the curved side 204. The curvature of the curved side 204 ensures the light is not reflected to the straight side 203. The shape of the microtip 202 captures the incoming light 201 and launches it into the core of the optical fiber. FIG. 2B illustrates a photograph of the microtips of a fiber optic-coupled microtip gas sensor in accordance with an embodiment. As can readily be appreciated, any of a variety of microtip shapes can be utilized for the microtip sensors as appropriate to the requirements of specific applications in accordance with various embodiments of the invention.

The microtips 106 can be separated by a certain distance to make an accurate detection of the target gas. The gap between the microtips with a fixed distance d is where the gas phase measurement is made. The distance d depends on the absorption feature of the target molecule. In certain embodiments, the incoming light is reflected between the microtips multiple times to achieve a desired length for detection. In several embodiments, the fiber optic microtips 106 can have an anti-reflective coating. In some embodiments, the optical fiber tips 106 are separated by millimeters such as (but not limited to) about 0.5 mm, or about 1 mm, or about 1.5 mm, or about 2 mm, or about 2.5 mm, or about 3 mm, or about 3.5 mm, or about 4 mm, or about 4.5 mm, or about 5 mm, gaseous substance detection. In certain embodiments, the optical fiber tips 106 are separated by about 1 mm for carbon dioxide and water vapor measurements. As can readily be appreciated, any of a variety of separation distances can be incorporated in the microtip sensors as appropriate to the requirements of specific applications in accordance with various embodiments of the invention. The detections can be useful for human exploration and lunar water extraction.

The tunable laser spectroscopy is self-calibrating, and its accuracy is tied to how well the separation of fiber tips are held to one fixed distance. The stabilizing unit 105 can hold the fiber optics and stabilize the optical fiber tips and keep the separation distance d at a fixed distance. The stabilizing unit 105 can be made of materials that have a similar coefficient of thermal expansion to glass. Such materials can allow a tight mechanical joint between the optical fibers and the stabilizing unit over a range of temperatures such that the optical fiber tips can be held at a fixed distance. Examples of materials for the stabilizing unit include (but are not limited to) nickel-cobalt ferrous alloys, nickel-iron alloys, Kovar, Invar. As can readily be appreciated, any of a variety of materials can be utilized for the stabilizing unit as appropriate to the requirements of specific applications in accordance with various embodiments of the invention.

In some embodiments, the incoming light (such as a laser) sweeps between the microtips 106 and detects the fingerprint patterns. The photodetector 104 can detect the fingerprint pattern of the target gas. Based on the fingerprint pattern, the amount of chemical between the microtips 106 can be determined. In some embodiments, the gas at the microtips 106 absorbs the incoming light (such as a light emitting diode) such that the number of photons detected at the photodetector 104 will decrease. The relationship between the number of photons detected and the gas can be calibrated for detection.

The flexibility and small size of the fiber optics enable a broad range of applications of these sensors. The fiber optics-coupled microtip sensors can be placed near a sample, or integrated into spacesuits, space capsules, and/or lunar regolith processing stations. Unlike hollow core fibers which need to draw in sample and thus need pumps, and have slow response times, the fiber optics-coupled microtip sensing systems can perform measurements at the microtip and can measure up to MHz rates.

In several embodiments, the fiber optics-coupled microtip sensors can be calibrated to a known concentration of gas to ensure measurement accuracy. The accuracy of the sensor can be within 0.1% of the pre-calibrated value, or within 0.2% of the pre-calibrated value, or within 0.3% of the pre-calibrated value, or within 0.4% of the pre-calibrated value, or within 0.5% of the pre-calibrated value. In some embodiments, the sensor can detect a wide range of gas concentration such as (but not limited to) about 1%, or about 2%, or about 3%, or about 4%, or about 5%, or about 6%, or about 7%, or about 8%, or about 9%, or about 10%, or about 10% to about 20%, or about 20% to 30%, or about 30% to about 40%, or about 40% to about 50%, or about 50% to about 60%, or about 60% to about 70%, or about 70% to about 80%, or about 80% to about 90%, or about 90% to about 99%. As can readily be appreciated, any of a variety of gas concentrations can be detected using the microtip sensors as appropriate to the requirements of specific applications in accordance with various embodiments of the invention. Certain embodiments calibrate the sensors to measure about 1%+0.1% carbon dioxide concentration. The accuracy of the fiber optics-coupled microtip sensors enable the sensors to be used in precision measurement.

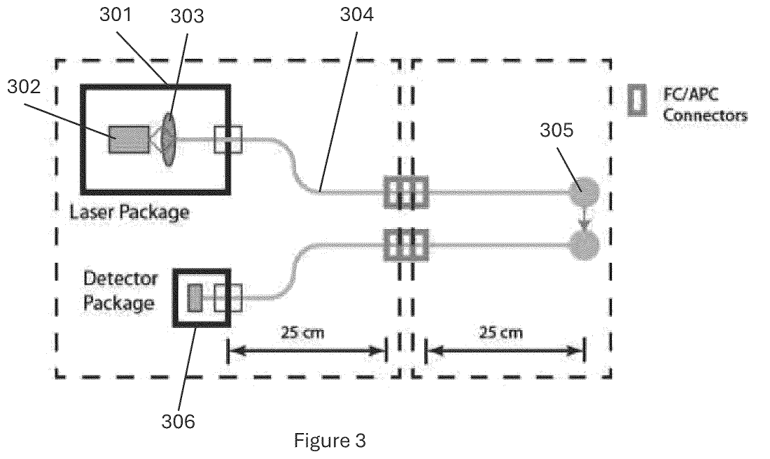

FIG. 3 illustrates an overall schematic of the fiber optics-coupled microtip sensor in accordance with an embodiment. The lasers launch laser light into the fiber inside a butterfly package. The fibers (which can be different material than the tips) bring the light to the microtip. The fibers then bring the light back to impinge on a detector which gives the measurement. The laser package 301 can be a butterfly laser package. The laser chip 302 is hermetically sealed with the integrated thermoelectrical cooler (TEC) lens 303. The laser beam travels down the fiber 304 where it is launched into free space via the microtip 305, then collected by a lensed fiber and brought to a detector 306.

While various packaging of the microtip sensors are described above with reference to FIG. 3, any variety of packages that can integrate the microtip sensors can be utilized as appropriate to the requirements of specific applications in accordance with various embodiments of the invention.

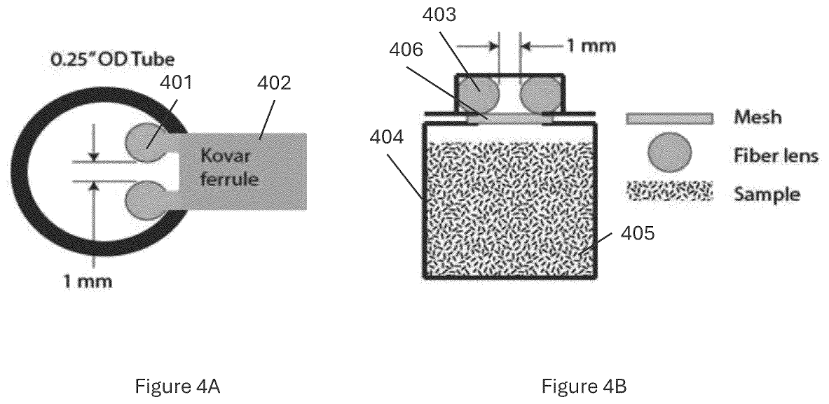

In many embodiments, the fiber optics-coupled microtip sensor can be integrated into various applications. In some embodiments, the microtip sensor can be inserted into a tube transporting gas from one processing step to another. The microtip sensor can monitor the gas concentration through the tube. In certain embodiments, the tube can be a portion of a spacesuit or an in-situ resource utilization (ISRU) processing unit. FIG. 4A illustrates a schematic of implementation of the fiber optics-coupled microtip sensor in accordance with an embodiment. The sensor (showing only the microtip 401 and the stabilizing unit 402) can be placed inside a tube for monitoring the gas stream through the tube. The stabilizing unit 402 can be a ferrule made of Kovar.

In some embodiments, the microtip sensor can be used to measure gas concentrations from a sample directly. The microtip sensor can be placed near the sample for detection. FIG. 4B illustrates a schematic of implementation of the fiber optics-coupled microtip sensor in accordance with an embodiment. The sensor (showing only the microtip 403) can be integrated on top of a crucible 404 holding a solid sample 405. A mesh 406 can be placed between the crucible 404 and the microtip 403 to prevent contamination. The solid sample 405 can be soil.

While various applications for using the microtip sensors are described above with reference to FIG. 4A and FIG. 4B, any variety of applications that can integrate the microtip sensors can be utilized as appropriate to the requirements of specific applications in accordance with various embodiments of the invention.

### Doctrine of Equivalents

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a”, “an”, and “the” may include plural referents unless the context clearly dictates otherwise. Reference to an object in the singular is not intended to mean “one and only one” unless explicitly so stated, but rather “one or more”.

As used herein, the terms “approximately”, and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A gas sensor, comprising:
a light source emitting a light;
a first fiber optic connected to the light source, wherein a first end of the first fiber optic is configured to collimate the light;
a second fiber optic with a first end separated by a fixed distance from the first end of the first fiber optic, wherein the collimated light emitted from the first end of the first fiber optic crosses the fixed distance and is received by the first end of the second fiber optic; wherein the light is coupled between the first end of the first fiber optic and the first end of the second fiber optic;
a stabilizing unit configured to hold the first end of the first fiber optic and the first end of the second fiber optic stationary and at the fixed distance to allow the coupling of the light in between; and
a photodetector connected to the second fiber optic, wherein the photodetector measures an optical signal induced by a change in characters of the light in the fixed distance between the first end of the first fiber optic and the first end of the second fiber optic.

2. The gas sensor of claim 1, wherein the light source is a light emitting diode.

3. The gas sensor of claim 1, wherein the light source is a tunable laser.

4. The gas sensor of claim 3, wherein a wavelength or frequency of the tunable laser is tuned to a plurality of resonance lines of the gas.

5. The gas sensor of claim 3, wherein the tunable laser is a part of a laser package.

6. The gas sensor of claim 1, the first fiber optic and the second fiber optic each comprise a fiber optic material that transmits the light.

7. The gas sensor of claim 6, wherein the fiber optic material is selected from the group consisting of: quartz, silica, fused silica, and ZBLAN glass.

8. The gas sensor of claim 1, wherein the first end of the first fiber optic comprises a straight side and a curved side, wherein the straight side collimates the light and the curved side transmits the collimated light to the first end of the second fiber optic.

9. The gas sensor of claim 1, wherein the fixed distance is selected based on a plurality of absorption features of the gas.

10. The gas sensor of claim 1, wherein the fixed distance is greater than or equal to 0.5 mm and less than or equal to 10 mm.

11. The gas sensor of claim 1, wherein the fixed distance is 1 mm.

12. The gas sensor of claim 1, wherein the stabilizing unit comprises a material of a similar coefficient of thermal expansion as the first fiber optic and/or the second fiber optic.

13. The gas sensor of claim 1, wherein the stabilizing unit comprises a material selected from the group consisting of: a nickel-cobalt ferrous alloy, a nickel-iron alloy, Kovar, and Invar.

14. The gas sensor of claim 1, wherein the gas sensor is a portion of a spacesuit or an in-situ resource utilization (ISRU) processing unit.

15. The gas sensor of claim 1, wherein the gas is selected from the group consisting of: carbon dioxide, oxygen, methane, and water vapor.

16. A method for detecting a gas, comprising:
measuring a concentration of the gas using a gas sensor, wherein the gas sensor comprises:
a light source emitting a light;
a first fiber optic connected to the light source, wherein a first end of the first fiber optic is configured to collimate the light;
a second fiber optic with a first end separated by a fixed distance from the first end of the first fiber optic, wherein the collimated light emitted from the first end of the first fiber optic crosses the fixed distance and is received by the first end of the second fiber optic; wherein the light is coupled between the first end of the first fiber optic and the first end of the second fiber optic;
a stabilizing unit configured to hold the first end of the first fiber optic and the first end of the second fiber optic stationary and at the fixed distance to allow the coupling of the light in between; and
a photodetector connected to the second fiber optic, wherein the photodetector measures an optical signal induced by a change in characters of the light in the fixed distance between the first end of the first fiber optic and the first end of the second fiber optic; and
determining the concentration of the gas based on the optical signal measured by the photodetector.

17. The method of claim 16, further comprises calibrating the gas sensor to a known concentration of the gas.

18. The method of claim 16, wherein the light source is a tunable laser.

19. The method of claim 16, wherein the first fiber optic and the second fiber optic each comprise a fiber optic material that transmits the light; wherein the fiber optic material is selected from the group consisting of: quartz, silica, fused silica, and ZBLAN glass.

20. The method of claim 16, wherein the first end of the first fiber optic comprises a straight side and a curved side, wherein the straight side collimates the light and the curved side transmits the collimated light to the first end of the second fiber optic.

21. The method of claim 16, wherein the fixed distance is greater than or equal to 0.5 mm and less than or equal to 10 mm.

22. The method of claim 16, wherein the stabilizing unit comprises a material selected from the group consisting of: a nickel-cobalt ferrous alloy, a nickel-iron alloy, Kovar, and Invar.
